(19) United States
(12) Patent Application Publication
(10) Pub. No.: US 2013/0284805 A1
(43) Pub. Date: Oct. 31, 2013

(54) Kiosk For Providing Customized Transaction Cards To Customers

(71) Applicant: Ward Kraft, Inc., (US)

(72) Inventors: Roger E. Kraft, Fort Scott, KS (US); William R. Russell, Pittsburg, KS (US); Jesse D. Crum, Fort Scott, KS (US); Ryan Kraft, Fort Scott, KS (US); Rachel E. Wells, Fort Scott, KS (US)

(73) Assignee: Ward Kraft, Inc., Fort Scott, KS (US)

(21) Appl. No.: 13/854,593

(22) Filed: Apr. 1, 2013

Related U.S. Application Data
(63) Continuation-in-part of application No. 13/831,414, filed on Mar. 14, 2013.
Application No. 13/831,414 is a continuation of application No. 13/245,427, filed on Sep. 26, 2011, now Pat. No. 8,429,021.
Application No. 13/245,427 is a continuation-in-part of application No. 11/901,185, filed on Sep. 14, 2007, now Pat. No. 8,036,951.
(60) Provisional application No. 61/532,396, filed on Sep. 8, 2011.

(51) Int. Cl. G07F 11/62

(52) U.S. Cl. CPC G07F 11/62
USPC 235/381

(57) ABSTRACT

A system for incentivizing purchases by consumers comprises a kiosk configured to appraise an item. A composition of the item is determined using an evaluating device. A cash value is associated with the item using data obtained by the evaluating device and market data obtained over a network, and an exchange value of the item is determined by subtracting a processing fee from the cash value. At least one of the cash value and the exchange value is relayed to the consumer on an output device. The consumer is asked to select via an input device between at least a first offer and a second offer in exchange for the item. A kiosk or mall booth for buying and receiving credit transaction cards, debit transaction cards, gift transaction cards, or coupons is also disclosed.

### CROSS-REFERENCES TO RELATED APPLICATIONS

This application is a continuation-in-part of U.S. patent application Ser. No. 13/831,414 filed Mar. 14, 2013, which is a continuation of U.S. patent application Ser. No. 13/245,427 filed Sep. 26, 2011, which: (a) is a continuation-in-part of U.S. patent application Ser. No. 11/901,185 filed Sep. 14, 2007, now U.S. Pat. No. 8,036,951; and (b) claims priority to U.S. Provisional Patent Application Ser. No. 61/532,396 filed Sep. 8, 2011. The disclosure of each is incorporated herein by reference in its entirety.

### FIELD OF THE INVENTION

The present invention relates to a combination retailing system that appraises for its users items having precious or semi-precious stones and/or metals. The combination retailing system may allow the users to relinquish their items in return for cash. The system may also provide an avenue for retailers, including online retailers, to offer incentives to users to entice them to accept, instead of the cash, coupons, gift cards and the like. A further embodiment comprises a kiosk allowing customers to purchase transaction cards such as credit transaction cards, debit transaction cards, gift transaction cards, or coupons.

### BRIEF SUMMARY OF THE INVENTION

The disclosed embodiments include systems and methods for appraising items having a precious stone, a semi-precious stone, a precious metal, or a semi-precious metal. According to one embodiment, a method for retailers to incentivize purchases by consumers comprises a transaction kiosk performing the step of physically receiving an item to be appraised from a consumer. The item has at least one constituent selected from the group consisting of a precious stone, a semi-precious stone, a precious metal, and a semi-precious metal. The method includes the step of determining a composition of the item using an evaluating device. A cash value is associated with the item using data obtained by the evaluating device and market data obtained over a network. An exchange value of the item is determined by subtracting from the cash value a processing fee. At least one of the cash value and the exchange value is relayed to the consumer on an output device. The consumer is asked to select via an input device between at least a first offer and a second offer in exchange for the item. The first offer includes a first article associated with a first retailer, and the second offer includes a second article associated with a second retailer. A monetary value of at least one of the first article and the second article is greater than the exchange value of the item. In an alternative embodiment a kiosk or kiosk/mall booth combination is provided at which customer may purchase transaction cards such as credit transaction cards, debit transaction cards, gift transaction cards, or coupons.

According to another embodiment, a system for increasing traffic in a shopping center comprises a kiosk. The kiosk is configured to appraise an item physically received from a consumer. The item has at least one constituent selected from the group consisting of a precious stone, a semi-precious stone, a precious metal, and a semi-precious metal. A composition of the item is determined using an evaluating device. A cash value is associated with the item using data obtained by the evaluating device and market data obtained over a network. An exchange value of the item is determined by subtracting from the cash value a processing fee. The exchange value is relayed to the consumer. The consumer is asked to select between at least a first gift card and a second gift card in exchange for the item. The first gift card is associated with a first group of retailers that includes a first retailer. The second gift card is associated with a second group of retailers that excludes the first retailer. A monetary value of the first gift card is different from a monetary value of the second gift card.

According to yet another embodiment, a system for incentivizing purchases by consumers comprises a kiosk configured to appraise an item physically received from a consumer. The item has at least one constituent selected from the group consisting of a precious stone, a semi-precious stone, a precious metal, and a semi-precious metal. A composition of the item is determined using an evaluating device. A cash value is associated with the item using data obtained by the evaluating device and market data obtained over a network. An exchange value of the item is determined by subtracting a processing fee from the cash value. At least one of the cash value and the exchange value is relayed to the consumer on an output device. The consumer is asked to select via an input device between at least a first offer, a second offer, and a third offer in exchange for the item. The first offer includes a first article associated with a first retailer. The second offer includes a second article associated with a second retailer. The third offer includes monies equal to the exchange value. A monetary value of at least one of the first article and the second article is greater than the exchange value of the item.

### BRIEF DESCRIPTION OF THE DRAWINGS

Illustrative embodiments of the present invention are described in detail below with reference to the attached drawings, wherein:

FIG. 1 depicts a schematic of a retail location, such as a fixed installation store and the like;

FIG. 2 is a perspective view of a kiosk according to one embodiment of the current invention;

FIG. 3 shows the various elements of the kiosk of FIG. 2 and illustrates electronic communication;

FIGS. 4A and 4B illustrate operation of one portion of the kiosk of FIG. 2; and

FIGS. 5 and 6A through 6C illustrate programming in the kiosk of FIG. 2 and methods of using the kiosk of FIG. 2.

FIG. 7 is a schematic drawing of a kiosk for buying and receiving credit transaction cards, debit transaction cards, gift transaction cards, or coupons.

### DETAILED DESCRIPTION

The present invention is directed to a combination retailing system that offers a series of consumer goods, precious or semi-precious stones and metals, and ready to eat convenience food products at a single location. This combination retailing system also provides an avenue for customers to have their precious or semi-precious stones and metals appraised. Customers may utilize the time during which their precious or semi-precious stones and metals are being appraised to enjoy the variety of consumer goods and convenience food products made available by the combination retailing system. After the appraisal, the retailing system provides customers with the opportunity to trade or sell their precious or semi-precious stones and metals.

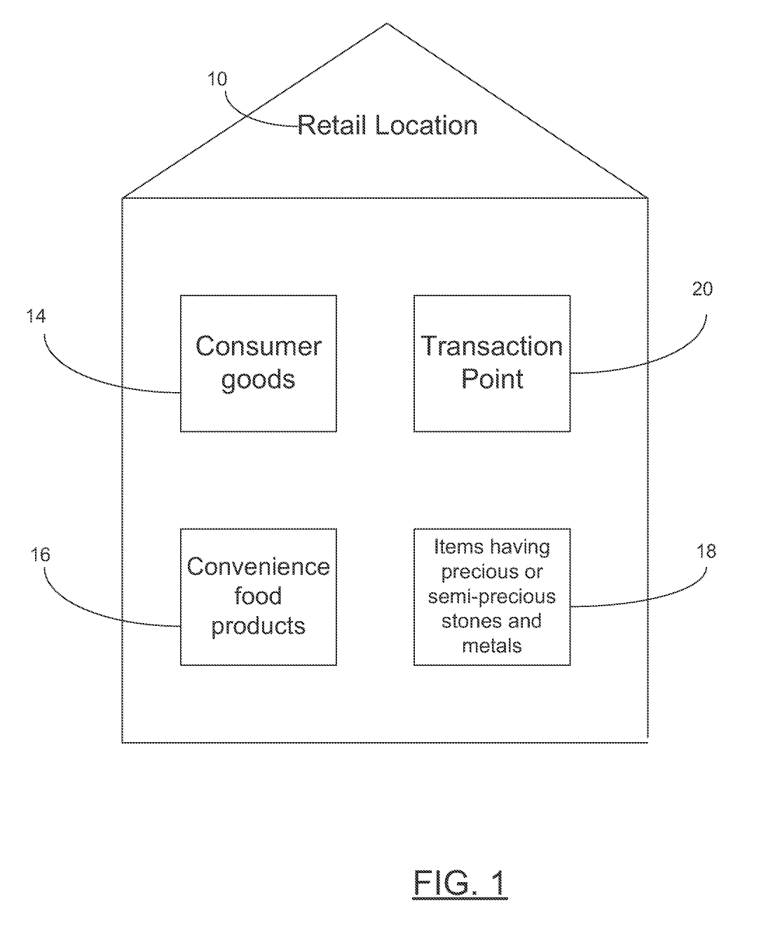

Reference is now directed to FIG. 1, which includes a schematic of a retail location (or “point-of-purchase”) 10. The retail location 10 may carry a variety of consumer goods 14, which may include magazines, newspapers, health and beauty products, household items, seasonal or regional offerings, general retailing merchandize, et cetera, and convenience food products 16, which may include any product commonly consumed as food or drink, such as fast food items, chips, candy, fruit, juices, coffee, tea, organic foods, and the like. The retail location 10 may also carry valuable items 18 that include precious or semi-precious stones and metals, such as diamond necklaces, gold chains, silver bracelets, platinum rings, pearl earrings, bars or coins of gold, silver, or platinum, or a cut or uncut diamond, emerald, pearl, or other gem.

A transaction point 20 may be provided at the retail location 10. The transaction point 20 will be used by the customers to place one or more transactions for the consumer goods 14, convenience food products 16, and valuable items 18 being offered at the retail location 10. The transaction point 20 can include a sales person, a video display, such as a touch screen, computer terminal, telecommunications equipment, such as a telephone or facsimile machine or combinations of any of the foregoing.

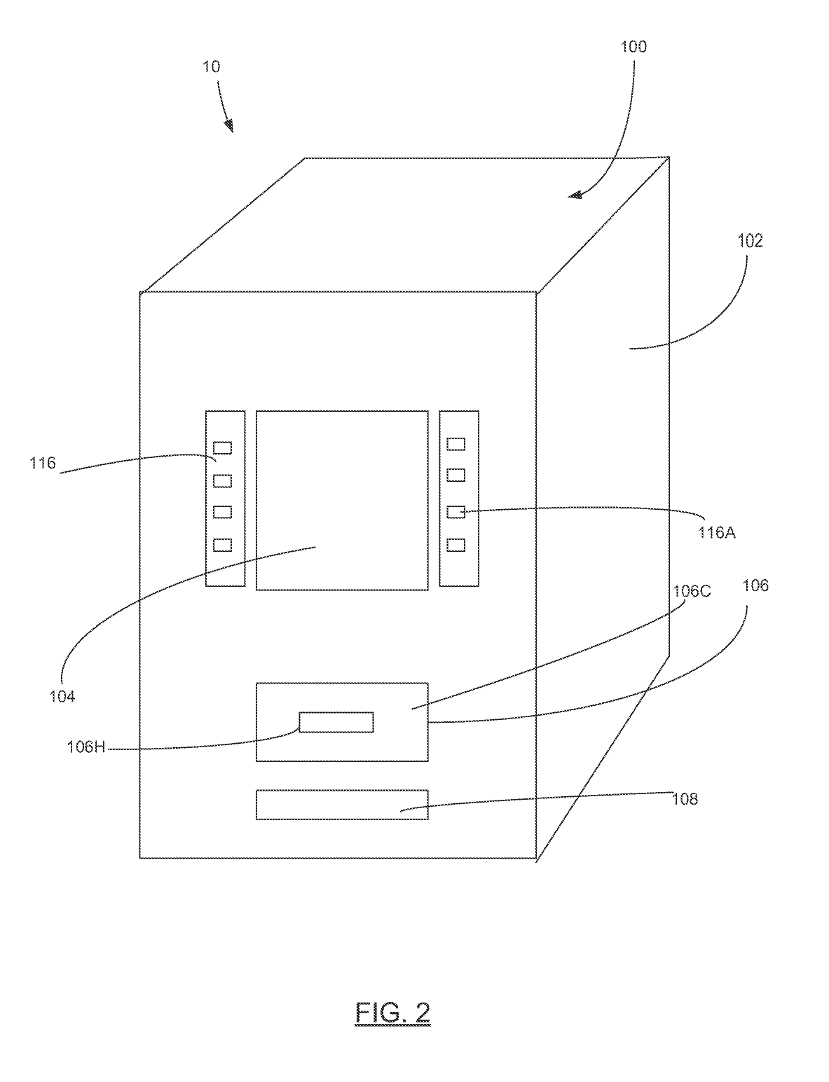

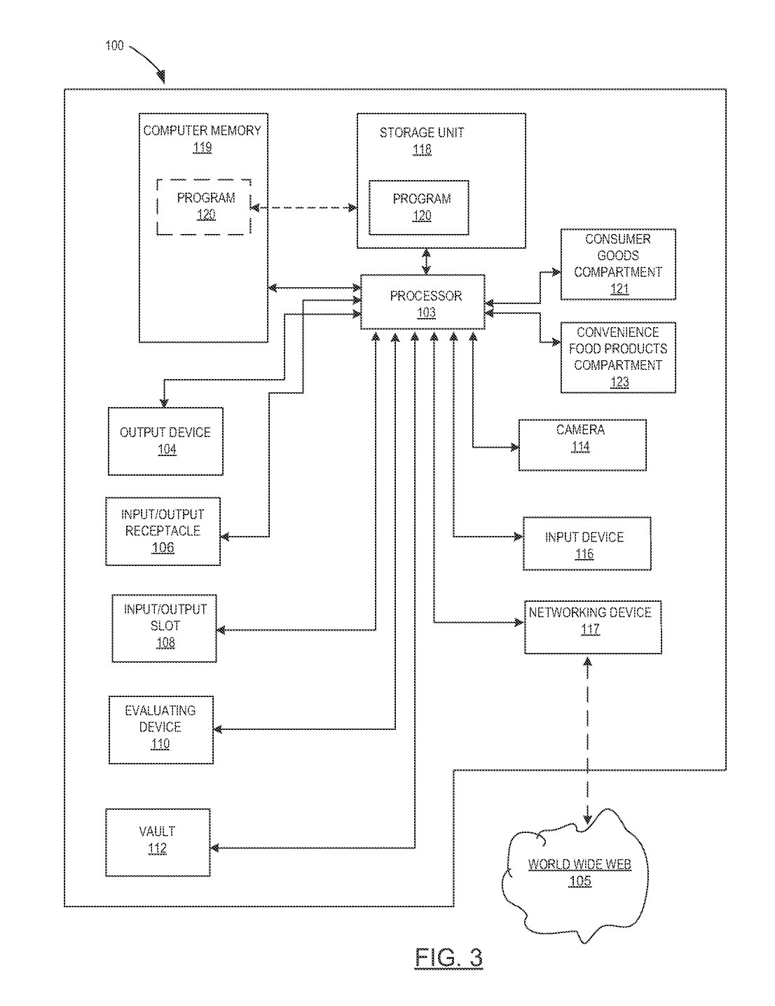

The retail location 10 may be a fixed retail outlet, such as a store in an indoor or outdoor shopping mall or a standalone store, and as shown in FIG. 1, may have a series of walls, a floor, a roof, and other features commonly associated with a store. As shown in FIGS. 2 and 3, the retail location 10 may also comprise a kiosk 100 that can be assembled by or within a larger structure such as a shopping mall or department store and which provides a functional retailing system as described in the embodiments of the present invention. The kiosk 100 may be manually operated, or may be fully or partially automated.

According to one embodiment, the kiosk 100 includes an outer casing (or “housing”) 102 and a processor 103 which may be in data communication with an output device 104, a input/output receptacle 106, an input/output slot 108, an evaluating device 110, a vault 112, a camera 114, an input device 116, a networking device 117, a compartment 121 for storing consumer goods 14, and a compartment 123 for storing convenience food products 16.

The kiosk 100 also includes a storage unit 118 and a computer memory 119 in data communication with the processor 103. The storage unit 118 may be, for example, a disk drive that stores programs and data, and the storage unit 118 is illustratively shown storing a program 120 embodying the steps and methods set forth below. It should be understood that the program 120 could be broken into subprograms and stored in storage units of separate computers and that data could be transferred between those storage units using methods known in the art. A dashed outline within the computer memory 119 represents the software program 120 loaded into the computer memory 119 and a dashed line between the storage unit 118 and the computer memory 119 illustrates the transfer of the program 120 between the storage unit 118 and the computer memory 119.

The output device 104 may be an LCD or Plasma type display screen, a printer, or any other appropriate visual and/or audible output device, whether currently available or later invented. It may be desirable for the input device 116 to be placed close to the output device 104, and the input device 116 may include various keys 116A to help in the navigation of various options 140 (discussed below). It will be understood that the shape and placement of the input device 116 and the keys 116A in FIG. 2 are exemplary only, and that the input device 116 may be placed further away from the output 104, or may include different types of keys 116A (e.g., keys displaying letters of the alphabet and numerals). In addition, the input device 116 in different embodiments may include switches, knobs, biometric sensors, and any other appropriate input devices, whether currently available or later invented. If the output device 104 is capable of allowing a customer to scroll through and navigate the various options 140 (e.g., touch screen capability), the output device 104 and the input device 116 may be a single device. Nevertheless, embodiments having an output device 104 with such capability and also a separate input device 116 are also contemplated.

The input/output receptacle 106 may be covered with a cover 106C to which a handle 106H is secured, and a customer may move the cover 106C (e.g., downwardly) by using the handle 106H to gain access to the receptacle 106. The receptacle 106 may alternatively be a drawer, which can be pulled out by the handle 106H. Regardless of its specific construction, the receptacle 106 may be configured to receive and/or dispense valuable items 18 such as precious or semi-precious stones and metals in various forms. The receptacle 106 may also be configured to dispense consumer goods 14 and convenience food products 16. Those skilled in the art will appreciate that the input/output receptacle 106 may be a single receptacle, as previously described, or may instead include multiple receptacles.

The input/output slot 108 may be configured to input and output cash, cards (e.g., gift cards, debit cards, credit cards, etc.), and/or promotional materials such as coupons and vouchers. The input/output slot 108 may be a single slot, or may instead include multiple transfer devices.

The evaluating device 110 is configured to evaluate the contents and price of the valuable item 18. The item 18 may, for example, be placed in the receptacle 106 by a customer, or may have been stored in the vault 112 after being placed in the receptacle 106 by a prior customer (or an owner or authorized attendant of the kiosk 100, et cetera). The evaluating device 110 may include a scale 131, and may employ various methods to determine the contents and price of an item 18, such as methods based on frequency testing, electrical conductivity, thermal conductivity, et cetera.

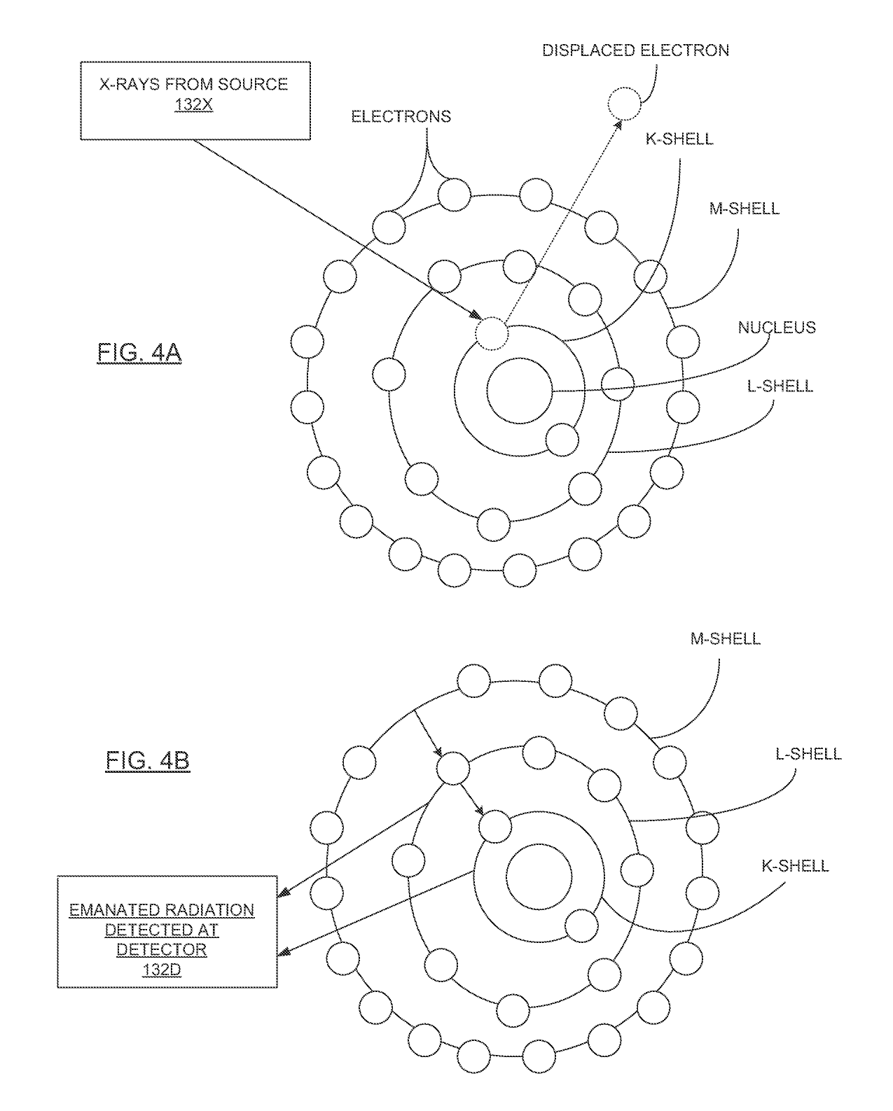

For instance, the evaluating device 110 may include an XRF (x-ray fluorescence) tester 132 which utilizes XRF to determine the types and quantity of metals present in an item 18. More particularly, the XRF tester 132 includes a source 132X, which can generate high energy, short wavelength protons (e.g., x-rays), and the item 18 is struck with these x-rays from the source 132X. The workings of the XRF-tester are explained here with reference to FIGS. 4A-4B.

The item 18, much like other matter, is composed of atoms, which, at their center, have a nucleus (see FIG. 4A). Rotating around the nucleus, in orbits, are negatively charged particles, i.e., electrons. These electrons rotate in different orbits (or shells) around the nucleus, and an electron in one shell has a different energy than an electron in another shell. For example, electrons in the K-shell, which shell is closest to the nucleus, have the lowest energy, whereas electrons in the M-shell, which is further away from the nucleus, have higher energy. Similarly, electrons in the L-shell, which lies between the K-shell and the M-shell, have greater energy than the electrons in the K shell, but less energy than the electrons in the M-shell.

When the item 18 is exposed to radiation emanated by the source 132X, an electron in a low energy shell (e.g., the K-shell) is displaced; thereafter, an electron in a higher energy orbit (e.g., the L-shell) rushes to take its place in the low energy shell. Similarly, the electron in the comparatively higher energy orbit (e.g., the M-shell) rushes to take the place of the electron that has rushed to take the place of the electron originally displaced by the radiation. As there is less energy required to maintain the lower energy orbits, when an electron from a higher energy orbit, e.g., the M-shell, moves and takes the place of an electron in the L-shell, excess energy (i.e., L x-ray) is emitted. Similarly, when the electron in the L-shell takes the place of the electron in the K-shell, excess energy (i.e., K x-ray) is emitted, and so on. These x-rays (e.g., K, L, M, N x-rays) are unique to each metal, akin to a fingerprint, and can then be analyzed by a detector 132D, which compares these x-rays to the known values of various metals. The evaluating device 110 can thus determine the exact composition of the various metals in the item 18 with precision. For example, by using the scale 131 and the XRF tester 132, the evaluating device 110 may find that the item 18 contains one ounce (28.34 grams) of gold, and ten grams of silver.

The evaluating device 110 may then employ a different method to determine whether the item 18 also includes a precious stone. For example, the evaluating device 110 may employ an infrared reflectance meter, a refractometer, a diamond fluorescence machine, a spectroscope, or a combination of these and other known techniques along with the scale 131 to determine the contents, weight, and type of any precious or semi-precious stones that are included in the item 18. For illustrative purposes, consider that after analyzing the item 18, the evaluating device 110 gleans that in addition to the ounce of gold and ten grams of silver, the item 18 includes a diamond that weighs 1 carat (0.2 grams).

The next step entails pricing the item 18. The processor 103, via known communication methods, can access a network 105 (e.g., the Internet). Specifically, the processor 105 accesses one or more websites 105W, which may be dedicated solely to the kiosks 100, using the networking device 117. In some embodiments, the website 105W is password protected and the content on the website 105W is encrypted to prevent unauthorized access; in other embodiments, the website 105W may be a publicly-available site that is not dedicated to the kiosks 100. The website 105W may include the price of each precious or semi-precious gemstone and metal, and may be updated regularly (e.g., daily) by authorized persons to reflect the current rates. The website 105W may also keep track of the area at which a particular kiosk 100 is located, as the price of gemstones and metals often varies with location.

So, for example, the processor 103 of a particular kiosk 100 may determine via the website 105W that the current rate of a diamond in the locality of the kiosk 100 is $1,000 per carat, the current rate of gold is $1,500 per ounce, and that the current rate of silver is 10 cents per gram. The processor 103 may then calculate (using the composition determined by the evaluating device 110) that the item 18 is worth about $2,501, and after deducting certain processing fees, may display the worth of the item 18 on the output device 104.

In some embodiments, the determined worth may be confirmed by using the camera 114; specifically, the camera 114, which may be a digital video (or still) camera, may make an image 136 of the item 18 and securely transmit the image 136 over the web 105. The image 136 may then be viewed by a jeweler or other person via the website 105W or some other website. The jeweler may then confirm that the readings taken by the evaluating device 110 are (or appear to be) correct, and may also modify the worth of the item 18. For example, the jeweler may lower the calculated worth of the item 18 upon finding that the diamond associated with the item 18 has inclusions which were not accounted for, or that the diamond is colored or has some other defect. Or, the jeweler may increase the calculated worth of the item 18 upon finding, for example, that the item 18 is associated with a particular brand.

If such remote valuation methods are employed, a customer may be able to communicate with the jeweler about the specifics of the item 18 by using the input device 116, output device 104, and camera 114; for example, the camera 114 may take a video 136 of the customer and cause it to be transmitted, whereby the video 136 may be viewed, generally simultaneously, by the jeweler. Or, the kiosk 100 may allow two-way video communication between the customer and the jeweler by displaying the jeweler on the output device 104. Or, the customer may instead utilize a telephone number to call the jeweler and discuss any concerns about the calculated worth of the item 18.

After deducting fees (20% for this example, and which may also include a factor of safety to ensure that the item is worth more than the evaluation) from the calculated worth, the offered price (now $2,000.80 in the current example) is displayed on the output device 104, and the customer may choose to sell the item 18. If so, the customer may navigate the input device 116, and the stated amount (again, $2,000.80 in the current example) may be dispensed by the kiosk 100 via the input/output slot 108C.

The item 18 may be stored in the vault 112. The vault 112 may be partitioned into various areas and may be fully encompassed by the casing 102, or may extend into a secure room or other structure through the back or a side of the kiosk 100. The vault 112 may include one or more safety mechanisms to ensure that the vault 112 is accessible only to authorized persons, and may include a hidden GPS device in case anyone attempts to improperly relocate the entire kiosk 100 or the vault 112.

Valuation of the item 18 as discussed above may take some time, and a customer getting an item 18 appraised may wish to utilize this time. Preferably, thus, a customer using the retail location 10 (e.g., kiosk 100) to get his item 18 valuated will also, at the transaction point 20, purchase a convenience food product 16, which the customer may consume while the appraisal is being conducted; or, the customer may instead purchase a consumer good 14 such as a magazine which the customer can browse through while waiting for the valuation to complete. In this manner, the retailing system provides a convenient and efficient manner in which to provide a valuable service to a customer without delaying or interrupting his schedule.

The consumer goods 14 may be stored inside the kiosk 100 within a compartment 121, and the convenience food products 16 may be stored within a compartment 123 (see FIG. 3). A heating or cooling element may be associated with the compartment 123 for storing and/or dispensing the convenience food products 16 at a desirable temperature. A person skilled in the art will understand that the compartments 121 and 123 for storing consumer goods 14 and convenience food products 16 respectively may be single compartments, or may comprise a plurality of compartments.

The outer casing 102 of the kiosk 100 may be such that a customer is able to view the contents of one or both compartments 121, 123 directly, or the contents of the compartments 121, 123 may be displayed on the output device 104 by the processor 130. The customer may be allowed to select a consumer good 14 and/or convenience food product 16 via the input device 116, and the consumer good 14 or convenience food product 16 may be dispensed for the customer by the kiosk 100 through the input/output receptacle 106. Where some or all of the convenience food products 16 are not conducive to being dispensed via the input/output receptacle 106 (for e.g., coffee), the kiosk 100 may include a separate dispensing unit to dispense such food products 16. It is also possible for the consumer goods 14 or food products 16 to be stored at a remote location (e.g., at a store or restaurant that is within a half hour drive from the retail location 10), and for them to be delivered to the retail location 10 after the customer has made his selection via the input device 116.

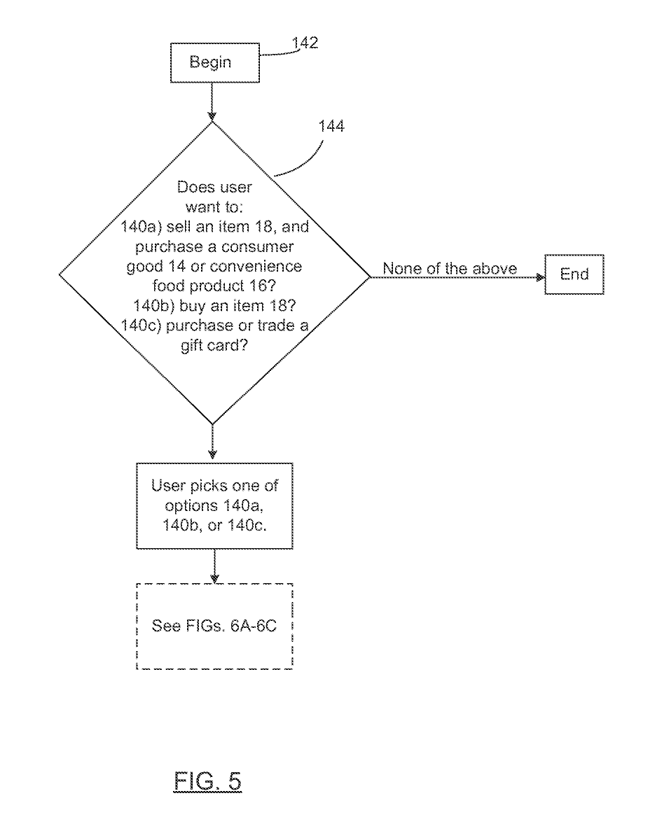

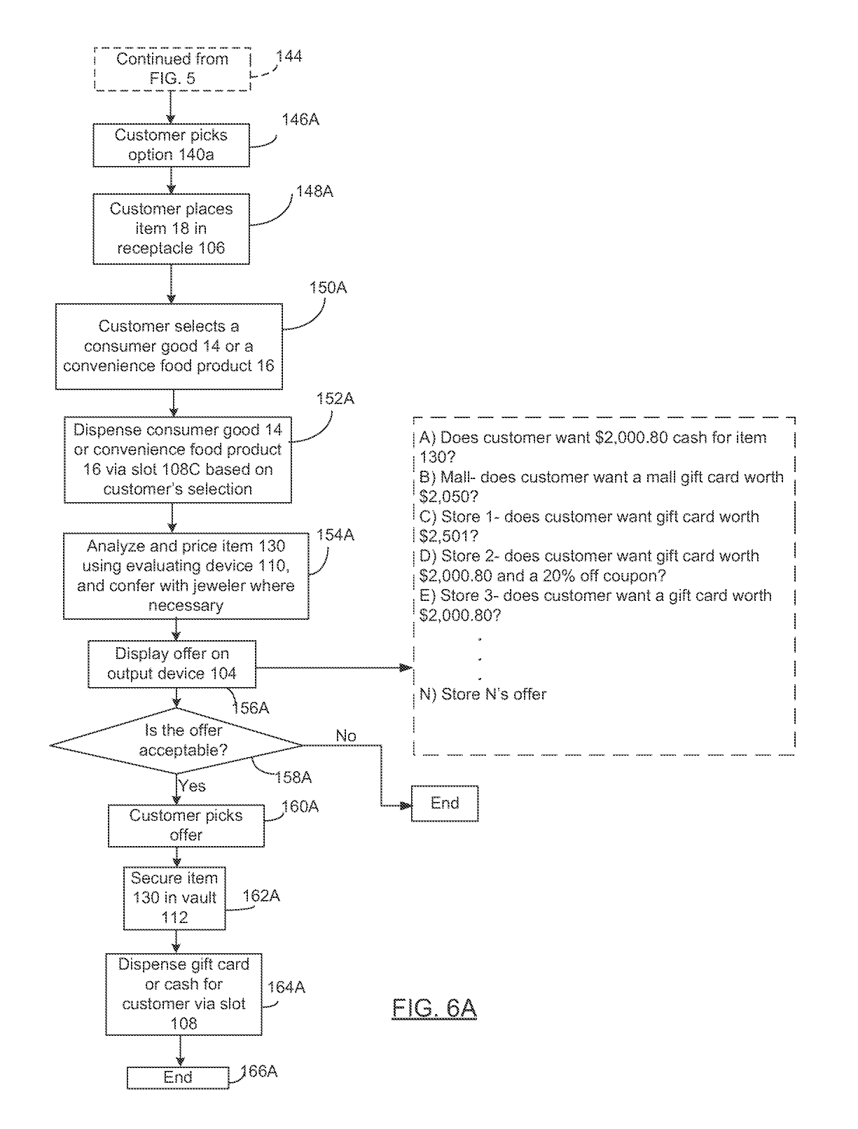

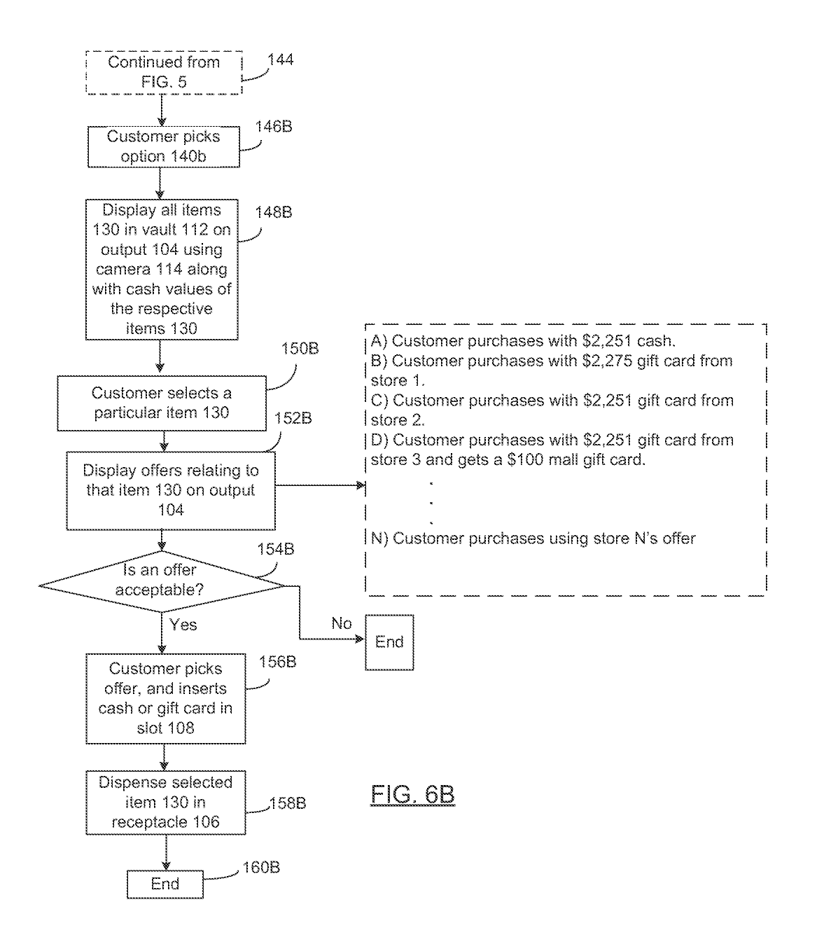

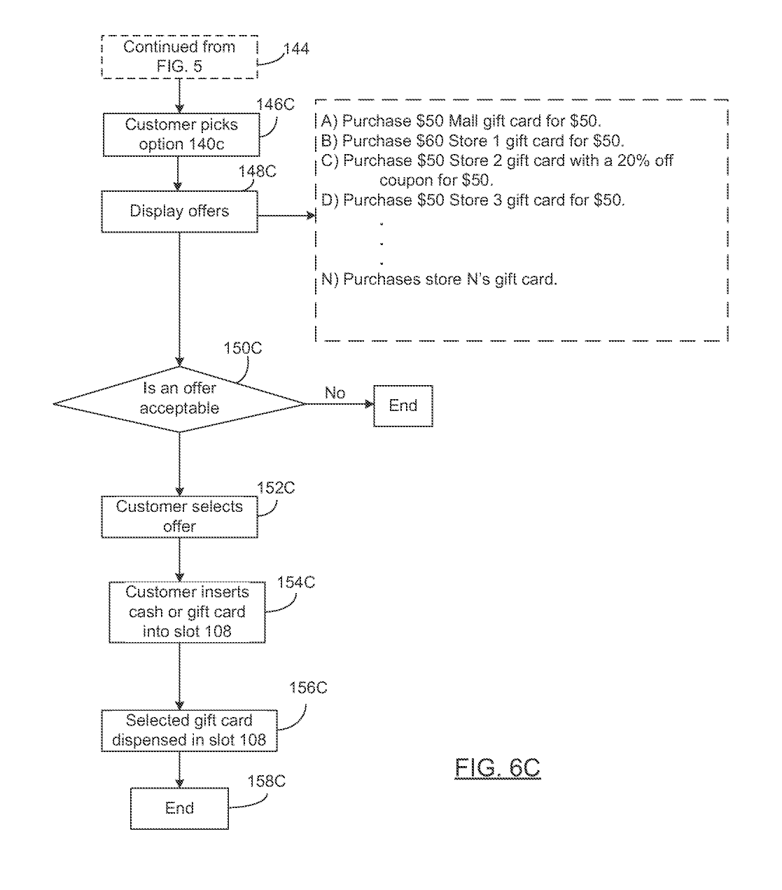

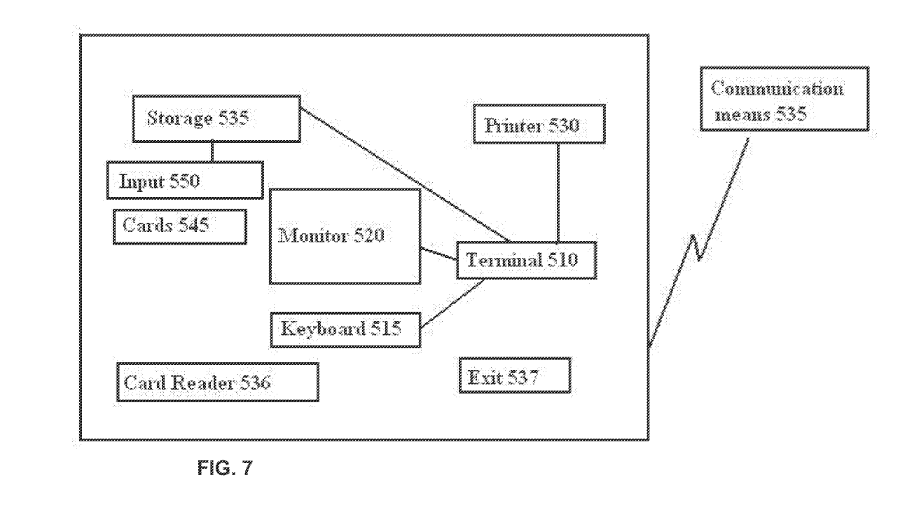

Attention is now directed to FIGS. 5 and 6A-6C, which illustrate programming in the kiosk 100 and methods of using the kiosk 100. In these illustrations, the kiosk 100 is placed, preferably conspicuously, in a mall or shopping area that has at least three stores, i.e., store 1, store 2, and store 3.

As shown in FIG. 5, at step 142, a customer enters the shopping area and approaches the retail location 10 (i.e., kiosk 100 in this example). At step 144, the kiosk 100, via its output device 104, inquires whether the customer is interested in selling an item 18 and purchasing a consumer good 14 or convenience food product 16 (option 140a), buying an item 18 (option 140b), or purchasing or trading a gift card (option 140c). FIG. 6A shows selection of option 140a, FIG. 6B shows selection of option 140b, and FIG. 6C shows selection of option 140c.

By selecting option 140a at step 146A (FIG. 6A), the customer signifies that he intends to sell an item 18, and wants to purchase a consumer good 14 or convenience food product 16. The item 18 may be any item that includes a precious or semi-precious stone or metal, or any item 18 that the customer thinks may include a precious or semi-precious stone or metal. At step 148A, the customer places his item 18 in the receptacle 106. Then, at step 150A, the customer is asked, via the output device 104, whether he wants to purchase a consumer good 14 or a convenience food product 16. At step 152A, the kiosk 100 dispenses the consumer good 14 or convenience food product 16 in line with customer's entry, which the customer may make using the input device 116. The customer may also choose to purchase both a consumer good 14 and a convenience food product 16, or a plurality of either.

At step 154A, the item 18 is evaluated by the evaluating device 110 to determine the contents of the item 18. Specifically, the evaluating device 110 may run one or more tests to determine the composition of the item 18, such as an X-ray fluorescence test by using its XFR tester 132 to determine the presence and composition of any precious or semi-precious metals, and/or tests for precious or semi-precious stones by using the spectroscope. The processor 103 may also ask the customer to input (via input 116) which metals and/or stones the customer want the item 18 to be tested for, and the evaluating device 110 may conduct only the tests pertaining to those metals and stones.

In some embodiments, the processor 103 (and software program 120) may cause the camera 114 to take video 136 (or snapshot) of the item 18 and stream the video 136 (or send the snapshot) over the internet 105, such that the video 136 (or snapshot) can be viewed by a jeweler or other qualified person. This may especially be useful where the tests conducted by the kiosk 100 provide inconsistent results or where the evaluating device 110 indicates that the item 18 is worth more than a predetermined amount, so that the jeweler can verify the worth of the item 18. It is also possible to instead have an attendant on hand that can verify the price of each item 18 and address any concerns of the customer, or for the kiosk 100 to simply refuse any transactions over a predetermined amount. Or, a phone number may be listed on the casing 102 of the kiosk 100 or displayed on the output device 104, allowing a customer to call that number and discuss any general or specific concerns.

Once the evaluating device 110 determines the specific composition of the item 18, the processor 103 may then communicate with the website 105W to determine the current unit price of each constituent metal or stone present in the item 18 in the locality of the kiosk 100. As with the example above, it may be determined that the item 18 has a one carat diamond, an ounce of gold, and 10 grams of silver, and as such, the processor 103 may calculate the item 18 to be worth about $2,501. The processor 103 may then deduct a standard amount or percentage and display on the output 104 the cash amount (e.g., $2,000.80) that the kiosk 100 is willing to pay for the item 18.

As the kiosk 100 additionally has the capability to dispense gift cards, the mall and the stores therein may compete with each other to entice the customer to, instead of cash, accept a gift card from the mall or a store. For example, the mall may offer the customer a gift card for $2,050-$49 more than what the kiosk 100 offers the customer in cash. The customer may consider the additional $49 to be worthwhile, especially because the mall gift card may be utilized at any store in the mall; for instance, the customer may rationalize that since the mall gift card has no imminent expiration date, and that the customer will have to spend cash anyway to purchase items of use (such as clothing, food, gifts, et cetera), that it is a better deal to take the higher value gift card than the cash. If the customer accepts the mall gift card, it would increase the likelihood that the customer would come to the mall again to shop, something which the customer may not have done otherwise. Thus, the presence of the kiosk 100 may entice a customer to come to the shopping area to conveniently sell an item 18, whether for cash or a gift card. And once a customer is at the shopping area to utilize the kiosk 100, the customer may shop at the shopping area after (or before) using the kiosk 100, even if he did not originally intend to do so.

There is no requirement that the mall gift card be priced higher than the cash value of the item 18, and if it is not, the customer may purchase the mall gift card nevertheless, perhaps as a gift, or because it is safer to carry the mall gift card than cash. The mall gift card may also extend to other malls or stores; this may especially be helpful when the kiosk 100 is placed in a store that has a chain of stores. For example, where the kiosk 100 is placed in a Walmart® store, a Bass Pro Shops® store, a Cabela's® store, or a gas station chain, the gift card may extend to all of these respective stores nationwide, or even internationally. Or, certain gift cards may extend to a particular grouping of stores, and also to restaurants, dry cleaning services, bars, salons, et cetera, allowing for a safe and convenient alternative to cash at many of the places that the customer frequents.

The stores within the mall may also (but do not have to) compete with each other to entice the customer to accept their gift card in return for the item 18, and may provide varying incentives to the customer. For example, store 1 may provide a gift card that is worth $2,501, i.e., the actual worth of the item 18 before the processing fee was subtracted, and thereby, agree to absorb the processing fee of the kiosk 100 on behalf of the customer, in return for the opportunity to have the customer shop at store 1. Store 2 may, for example, offer a store 2 gift card for $2,000.80 but add a 20% off coupon as an incentive. These offers will generally be determined in advance, may be changed from time to time, and may vary from kiosk 100 to kiosk 100. Again, however, there is no requirement that a store provide any additional incentives, and as such, store 3 may offer a gift card for $2,000.80, i.e., for the same amount that the kiosk 100 would dispense in cash.

At step 156A, all these offers may be displayed on the output device 104, and at step 158a, the kiosk 100 may inquire as to which offer the customer wants to take advantage of. If the customer picks an offer at step 160A, the kiosk 100 (and more specifically the processor 103 along with program 120) may first cause the item 18 to be secured in the vault 112 at step 162A. This ensures that the customer is unable to retrieve the item 18 after he has made the decision to accept an offer. The kiosk 100 may then, at step 164A, dispense the cash or gift card as selected by the customer in the slot 108, where it can be picked up by the customer. The kiosk 100 may also have the capability to dispense, instead of a gift card that is associated with a particular mall or chain, a debit card that can be used by the customer at any location that accepts debit cards. Or, if the customer desires, the kiosk 100 may transfer the funds electronically to the customer's bank account, or on the customer's behalf, to an internet retailer such as Amazon.com®. Similarly, the kiosk 100 may have the capability to transfer the funds to eBay® (e.g., via the customer's account at PayPal®), or to any other web based account where the funds can subsequently be accessed by the customer or a third party.

Returning now to step 144, if instead of attempting to sell an item 18, the customer wants to purchase an item 18, which item 18 may have been left in the kiosk 100 (i.e., the vault 112) by a prior customer, or an owner of the kiosk 100 or other authorized person, the customer selects option 140b at step 146B (FIG. 6B). The customer may for example be enticed to come to the kiosk 100 to purchase the item 18, instead of going to a jewelry or other store, because the item 18 may be offered at a lower price than it is elsewhere, as the cost of overhead of the kiosk 100 may be lower than that of stores; or, the customer may want to purchase an item 18 immediately (for e.g., as a gift for a party that night), and come to the kiosk 100 because the jewelry stores in the area have closed for the day. Or, for example, the customer may come to the kiosk 100 because the kiosk 100 may allow the customer to pay for an item 18 via a gift card, or because of the location of the kiosk 100.

After the customer selects option 140b at step 146B (FIG. 6B), the processor 103 at step 148B, by using the camera 114, may cause all the items 18 in the vault 112 to be displayed on the output 104 along with their prices in cash, which may have been pre-determined by the evaluating device 110, or may have been set in advance by an owner or authorized user of the kiosk 100. Once the customer selects a particular item 18 at step 150B, the kiosk 100 displays on display 104 the various offers relating to that item 18 at step 152B. These offers may include, for example, an offer from store 1 allowing the customer to purchase the item 18, which has a cash value of $2,251, with a gift card from store 1 for $2,275, and the customer, in his desire to utilize the gift card, may agree to this offer. Store 2 may offer that the customer purchase the item 18 with a gift card having the same cash value as the item 18, and store 3 may offer a $100 mall gift card if the customer purchases the item with a store 3 gift card worth $2,251. As discussed with respect to option 140a, there is no requirement that the offers from the stores be different, or even that every or any store in the shopping area participate in making the offers. Indeed, the kiosk 100 may be used inside a single retail store and only provide or accept gift cards from that store (though provided gift cards may be used in subsequent transactions to purchase different gift cards). A person skilled in the art will appreciate that the offers discussed with respect to the options 140, as well as the processing fees discussed herein are only exemplary.

If an offer is acceptable to the customer at step 154B, the customer picks the desired offer at step 156B and inserts into the slot 108 the cash or gift card according to the offer. This cash or gift card may also be secured in the vault 112 or a different secure area. Upon securing the cash or gift card, the kiosk 100 dispenses the desired item 18 into the receptacle at step 158B, thereby completing the transaction at step 160B. It will be appreciated by those skilled in the art that in addition to selling or buying an item 18 under options 140a, 140b respectively, the kiosk 100 may also, after deducting its fees, allow the customer to trade his item 18 for other item(s) 18 of comparable value.

Returning again to step 144, the kiosk 100 may in some embodiments also be used as a hub for buying gift cards relating to at least one store. For example, if the customer picks option 140c at step 146C (FIG. 6C), then at step 148C the kiosk 100 may display any or all offers relating to gift cards for cash. As before, the mall and the stores therein may compete with each other to entice the customer to purchase their gift card, by providing, for example, extra cash value for a gift card, or coupons or other incentives along with the gift card. Once a customer determines that an offer is acceptable at step 150C and selects an offer at step 152C, the customer inserts cash into the slot 108 at step 154C.

The kiosk 100 may also allow the customer to exchange a gift card from one store for a gift card from another store; for example, store 1 (or the mall) may offer to give a customer a gift card from store 1 (worth, e.g., $40) in exchange for a gift card from store 2 (worth, e.g., $50). Store 1 may then sell the gift card from store 2 via the kiosk 100 to another customer, and by virtue of the gift card from store 1, increase the likelihood that the customer will subsequently shop at store 1. The process ends at step 158C after the kiosk 100, at step 156C, dispenses the gift card selected by the customer.

The kiosk 100, thus, may allow a customer to conveniently have an item 18 having a precious or semi-precious metal or stone appraised and sold while providing the customer with avenues to utilize the time spent during the appraisal productively, to buy or trade an item 18, to buy a gift card for cash, or to exchange a gift card.

While the kiosk 100 has been detailed here in FIGS. 5 and 6A through 6C as being within a mall or shopping area, a person skilled in the art will appreciate that the kiosk 100 may be placed at any point-of-purchase, or at any other area that has high traffic or that has potential to attract high traffic. For example, the kiosk 100 may be placed within or outside a gas station, and may be integrated with the payment mechanisms utilized by the gas station. And, to illustrate, a customer having an item 18 for which the kiosk 100 is willing to pay $50 may utilize the kiosk 100 to pay $25 for gas and $5 for a convenience food product 16, and obtain the remaining $20 from the kiosk 100 in the form of a secure debit card that the customer can subsequently use at any location that accepts debit cards. It is also possible to place different types of kiosks 100 in proximity to each other to create an appraisal area 170. For example, a kiosk 100 that evaluates valuable items 18, dispenses consumer goods 14 and/or food products 16, and enables a user to trade his item 18 for another item 18 (or cash or gift cards et cetera) may be placed within one square mile of a kiosk 101 that has the ability to evaluate valuable items 18 and which enables a user to trade his item 18 for something of value, but which does not carry or dispense food products 16 or consumer goods 14.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

In a further exemplary embodiment, the retail location 10 is a free standing kiosk 500. The kiosk 500 is for use by customer. The kiosk 500 includes a computer terminal 510, a keyboard 515, a video monitor 520, which may be a touch screen monitor, a printer 530, a computer storage means 535 to contain, receive and store, forms, text, input, artwork and photographs, a credit/debit card reader 536, an exit slot 537, a suitable communication means 540, such as an internet connection, wide area network, local area network, or other wired or wireless communication system, and an input drive or port 550, such as a USB port for a flash drive or a disk drive.

The kiosk 500 may be used in malls, merchants' places of business, banks, or in other locations. The kiosk 500 may be made in any convenient shape, size, and configuration. Various elements of the kiosk 500 may be incorporated in a mall booth manned by an operator as described below.

The kiosk 500 contains transaction cards 545, including paper and plastic card stock, either pre-printed with various existing artwork selections or blank for printing selections provided by a customer. Some of the transaction cards 545 contain a credit card logo and hologram and may be used to issue credit cards. The credit card logo and hologram may be that of Visa®, Mastercard®, Discover Card®, or some other supplier or sponsor of credit cards. The transaction cards 545 may be used as gift message cards, gift cards, coupons, debit cards, or credit cards.

Blank transaction cards 545 may also be used to imprint the artwork, photos, and other content submitted by customers. In the alternative, the artwork may be predetermined with the customer selecting desired artwork from selections made available at the kiosk 500. If the transaction cards 545 require magnetic strips, an application programming interface may be used to encode the magnetic strips. In the alternative, the transaction cards 545 purchased at the kiosk 500 may be pre-encoded before being processed through the printer 530.

The kiosk 500 may also include gift packaging materials—i.e., paper or other material that may be used as a greeting card to contain the transaction card 545 that is purchased as a gift. The transaction card 545, once purchased, may then be placed in the gift packaging, along with a message, if desired, to present to the recipient of the gift. The gift packaging may be similar to a greeting card, with a slot, slit, or pocket for the transaction card 545 that is to be given to the recipient of the gift. The gift packaging may be printed by the printer 530 and dispensed through the exit slot 537.

The storage means 535 is coupled with the input port 550 and the terminal 510. The input port 550 allows a user or customer to input photographs or designs to be printed on the cards 545 to personalize the cards 545. The storage means 535 also allows the terminal 510 to store customer input in response to prompts and other information requests. The storage means 535 may also store forms, text, input, displays of the transaction cards 545, and other information necessary for making and using transactions cards 545.

The printer 530 is installed in the kiosk 500. The keyboard 515 is installed on an outer portion of the kiosk 500 so that it is accessible to the customer or user. Similarly, the video monitor 520 is installed so as to be accessible to a user or customer. As noted above, the video monitor 520 may have a touch screen for use by the customer instead of a mouse and keyboard 515 keys to move the cursor and make selections when prompted.

The communication means 540 is used to communicate with banks, credit card processors, authorizers, merchants, and others, including the party managing the kiosk 500. The communication means 540 may also be configured to send email for the purposes described below.

The kiosk 500 allows customers to purchase credit cards, debit cards, gift cards, coupons, and the like. It also allows the customer to prepare gift messages for the recipients of the coupons, gift cards, credit cards, or debit cards. The transaction cards 545 and gift messages may also be placed in gift packages which may be printed, as necessary, at the printer 530 and dispensed through the exit slot 537.

In an alternative embodiment the mall booth kiosk 500 is a mall booth. The kiosk 500 has dual monitors 520, dual connected computer terminals 510, and dual keyboards 515. The customer has access to one of the computer terminals 510, monitors 520, and keyboards 515. The booth is manned by an assistant or operator, who has access to the other computer terminal 510, monitor 520, and keyboard 515. The operator asks the customer questions concerning the desired transaction card 545 and makes appropriate selections on the terminal 510 to expedite the input of information necessary for the card 545. The various potential selections for the transaction card 545, the gift message, and the gift packaging are displayed on the customer's monitor 510, and the customer may select from the options shown on the customer's monitor 520. The customer may also input information necessary for the transaction card 545 through the use of the customer's monitor 520, the customer's computer terminal 510, and the customer's keyboard 515. Of course if touch screen monitors 520 are used, one or more of the keyboards 515 may not be necessary.

When the necessary information has been secured from the customer, the customer may view the final transaction card 545 on the customer's monitor 520. When the transaction card 545 is finalized, the customer uses the customer's terminal 510 to swipe his credit card to pay for the transaction, or alternatively, pays the operator using some form of payment other than a credit card. Once the payment has been made, the operator activates the transaction card 545, prints the transaction card 545 on the printer 530, and delivers the transaction card 545 to the customer. The gift message and the any gift package may be printed and/or assembled by the operator and given to the customer, as well.

Exemplary transactions using the kiosk 500 are described below.

### Gift Transaction Card

If the customer wishes to purchase a gift transaction card 545, the customer uses the keyboard 515 or the touch screen monitor 520 to select a merchant who will honor the gift card. In the alternative, the customer may be assisted by the operator in making such selection. The selection of a merchant may be made made from a list of merchants presented on the monitor 520. The customer may be prompted to use the keyboard 515 or touch screen monitor 520 to select the merchant and the amount of money or value to be associated with the gift card 545. The customer may also select the background image to be used on the card 545. Information designating the recipient of the gift card is then input into the computer storage means 535 of the kiosk 500, again via the keyboard 515.

If the customer wants a gift message to accompany the gift transaction card 545, the user is prompted to input (or use the previous input concerning the recipient) the name of the recipient and the message to be delivered to the recipient of the gift card. If the customer wishes to have the gift card to contain a personalized photo or artwork, the artwork or photo may be entered into the storage 535 via the input port 550. The customer may also select a package to contain the gift card 545.

After entry of the necessary information for printing the gift card 545 and/or gift message card, the amount of the gift card is charged to the customer's credit card or debit card, which may be read by the card reader 536 or input into the kiosk 500 by means of either the keyboard 515 or the touch screen monitor 520. The credit/debit card charge is communicated to the issuer of the credit/debit card via the communication means 540.

Upon completion of the charge to the customer's credit card 545, the communication means 540 may be used to communicate the dollar amount of the gift card to the merchant whose establishment will be used to redeem the gift card and credit the merchant's account with a prearranged amount by which the merchant is compensated for the gift card.

Thereafter, additional selections presented on the monitor 520 cause the desired gift card 545, together with any personalized artwork or photos and any gift message, to be printed on the card or cards 545 by the printer 530. The gift card 545, message, and packaging, if any, may, by another prompt and selection be caused to exit the kiosk 500 at the exit slot 537, where they may be received by the customer. In the alternative, the gift card and gift message may be directed to the recipient via email directly from the kiosk 500 and the terminal 510.

In the alternative, the kiosk 500 may be in a mall booth, and some of the functions may be performed by the operator in the mall booth in the manner described above or some other convenient arrangement or sharing of tasks.

### Credit Transaction Card

In the case of a credit trans action card 545, the customer uses the keyboard 515 or touch screen monitor 520 to make a selection to purchase a credit card 545 for the customer or a third party. Once the selection of the credit card 545 is made, the customer is prompted to use the keyboard 515 or touch screen monitor 520 to insert the name, address, dollar amount, and other information needed for the credit card 545 purchase.

If a gift message is desired for a third person, the gift message information may be input as stated above in the case of the gift transaction card 545. If the customer wishes the credit card 545 to contain a personalized photo or artwork, the artwork or photo may be input into the storage means 535 at a prompt or selection on the monitor 520. If the credit card 545 is a gift, the gift message and any gift package may be prepared in accordance with the method stated above with regard to gift messages to accompany gift cards.

Once the necessary information and artwork are input into the computer terminal 510, a prompt will require payment by the customer for the transaction via a credit card or debit card, the information for which may be read by a card reader 536 or input into the kiosk 500 by means of the keyboard 515 or touch screen monitor 520.

Upon acceptance of payment, the communication means 540 will communicate the credit card information to a bank or other authorizing institution to validate and activate the credit card being purchased. The credit card information may include the name and address of the recipient, as well as other information required by the issuer. The authorization and activation of the credit card will be communicated to the computer terminal 510 by the communication means 540. The authorization may be conditioned upon a guarantee from the customer or the recipient. If the recipient is to guarantee or acknowledge the credit card, the communication means 540 may also communicate with the recipient to secure the guarantee or acknowledgement from the recipient. If information or other agreements from the recipient are necessary, the activation may be delayed until that information is received from the recipient, who will then call the credit card issuer or processor in order to activate the card 545.

Upon response to a prompt, the printer 530 will print the credit card information on the card 545 that contains the credit card logo and the hologram. The gift message and any packaging may be printed upon further prompt and selection. In response to additional prompts, the card 545, message, and packaging may then be caused to exit the kiosk 500 at the exit 537 in the kiosk 500, where the customer may retrieve the credit card and message. In some cases, the credit card may be printed before authorization, validation, and activation by the bank, authorizing institution, or card processing company, in which case the credit card may be given to the recipients for activation by telephone with the authorizing party.

In the alternative, the kiosk 500 may be in a mall booth, and some of the functions may be performed by the operator in the mall booth in the manner described above or some other convenient arrangement or sharing of tasks.

### Debit Transaction Cards

In the case of debit transaction cards 545, the procedure is essentially the same as for credit cards, except the purchaser may be required to deposit sufficient funds in the authorizing bank to fund the debit card. In this case an existing account may be credited with the funds, or a new account may be set up via information input in the terminal 510 (as described above) and completion of the necessary information required by the bank to open the account. Any information needed from the owner of the account may also be secured from the owner of the account prior to activation of the debit transaction card 545. The card may then be printed by the printer 530 and caused to exit the kiosk 500 via the exit 537. The funding of the account may be made via the customer's credit card.

### Coupons

In the case of coupons, the customer uses the touch screen monitor 520 or keyboard 515 to select the coupon option on the kiosk 500. Various coupon books may be featured or advertised via the monitor 520 in as much detail as desired.

Once the selection of a coupon book is made via then monitor 520 or keyboard 515, a prompt will require payment for the coupon book via the customer's credit card or debit card, the information for which may be read by the card reader 536 or input into the kiosk 500 by means of the keyboard 515 or the touch screen monitor 520. Thereafter, upon response to a prompt, the kiosk 500 will eject the coupon book via the exit slot 537 where it may be retrieved by the customer.

Prior to the sale of the coupon books, the operator of the kiosk 500 will make arrangements with the merchants featured in the coupon book to secure their agreement to honor the coupons.

In the alternative, the kiosk 500 may offer individual coupons to be combined and placed in a booklet. In this alternative, the customer may select the coupons to be included in the book. In response to a prompt, the printer 530 will print the specific coupons purchased and make them available to the customer via the exit 537. In the alternative, the coupons may be emailed to the recipient via the communications means 540 in the terminal 510 of the kiosk 500.

In another embodiment, the kiosk 500 may be in a mall booth, and some of the functions may be performed by the operator in the mall booth in the manner described above or some other convenient arrangement or sharing of tasks.

It is claimed as follows:

1. A free standing kiosk at a retail location for dispensing transaction cards to customers, the kiosk comprising:
(a) a computer terminal comprising a keyboard, a video monitor,
a printer, and a computer storage means;
(b) a communication means associated with the computer terminal;
(c) a credit card reader for accepting payments; and
(d) an exit slot;
wherein, when the customer provides an input into the computer terminal via at least one of the monitor or the keyboard, a transaction card is selected, information of the transaction card is received and communicated by the communication means to an authorizing party, the communication means receives activation information form the authorizing party, the customer's payment is received via the card reader and communicated to and approved by the authorizing party, the transaction card is printed, and the transaction card is received by the customer in the exit slot.

2. The kiosk of claim 1 wherein the transaction card is a gift card.

3. The kiosk of claim 1 wherein the transaction card is a credit card.

4. The kiosk of claim 1 wherein the transaction card is a debit card.

5. The kiosk of claim 1 wherein the transaction card is a coupon.

6. The kiosk of claim 1 wherein the transaction card is accompanied by a message printed on the printer.

7. The kiosk of claim 6 wherein the message is received by the customer through the exit slot after the transaction card is received by the customer through the exit slot.

8. The kiosk of claim 1 wherein the transaction card is accompanied by packaging printed on the printer.

9. The kiosk of claim 8 wherein the packaging is received by the customer through the exit slot after the transaction card is received by the customer through the exit slot.

10. The kiosk of claim 1 wherein (a) the computer terminal has an input port for input of at least one of a customer's artwork, a photo, and a message, and (b) at least one of the customer's artwork, the photo, and the message is printed on at least one of a packaging and the transaction card.

11. The kiosk of claim 1 wherein the transaction card contains a credit card logo and hologram.

12. The kiosk of claim 1 wherein the transaction card is preauthorized by an authorizing party.

13. The kiosk of claim 1 wherein the customer receives authorization from an authorizing party after receiving the transaction card.

14. A mall booth kiosk at a retail location for dispensing transaction cards to customers with the assistance of an operator in the booth, the mall booth kiosk comprising:
(a) an operator computer terminal accessible to the operator comprising an operator keyboard, an operator video monitor, an operator printer, and an operator computer storage means;
(b) a customer computer terminal accessible to the customer comprising a customer video monitor, a customer keyboard, and a customer card reader for accepting payments;
(c) a communication means associated with at least one of the operator computer terminal the customer computer terminal;
wherein, when at least one of the customer or the operator provides input into the operator computer terminal via either the customer keyboard or the operator keyboard, a transaction card is selected, information for the transaction card is received by either the customer or operator terminal, the customer's payment is received via the card reader, the information for the transaction card is communicated via the communication means to an authorizing party, the communication means transmits activation information from the authorizing party, the transaction card is printed by the operator printer, and the transaction card is received by the customer or the operator.

15. The mall booth kiosk of claim 14 wherein the transaction card is a gift card.

16. The mall booth kiosk of claim 14 wherein the transaction card is a credit card.

17. The mall booth kiosk of claim 14 wherein the transaction card is a debit card.

18. The mall booth kiosk of claim 14 wherein the transaction card is a coupon.

19. The mall booth kiosk of claim 14 wherein the transaction card is accompanied by a message printed on the operator printer.

20. The mall booth kiosk of claim 19 wherein the message is received by the customer after the transaction card is received by the customer.

21. The mall booth kiosk of claim 14 wherein the transaction card is accompanied by a packaging printed on the operator printer.

22. The mall booth kiosk of claim 14 further comprising an exit slot; and
a packaging is received by the customer through the exit slot after the transaction card is received by the customer through the exit slot.

23. The mall booth kiosk of claim 14 wherein (a) either the operator computer terminal or the customer computer terminal has an input port for input of at least one of a customer's artwork, a photo, and a message, and (b) at least one of the customer's artwork, the photo, and the message is printed on at least one of the transaction card and a packaging.

24. The mall booth kiosk of claim 14 wherein the transaction card contains a credit card logo and hologram.

25. The mall booth kiosk of claim 14 wherein the transaction card is preauthorized by an authorizing party.

26. The mall booth kiosk of claim 14 wherein the customer receives authorization from an authorizing party after receiving the transaction card.
